(19) United States
(12) Patent Application Publication
(10) Pub. No.: US 2019/0012697 A1
(43) Pub. Date: Jan. 10, 2019

(54) RANKING CLIENT ENGAGEMENT TOOLS

(71) Applicant: Facebook, Inc., Menlo Park, CA (US)

(72) Inventors: Akash Nemani, Mountain View, CA (US); David Patrick Rohan, Menlo Park, CA (US); Sean Jude Taylor, San Francisco, CA (US); Anna Ginzburg-Kaplan, Alviso, CA (US); Adrien Thomas Friggeri, San Francisco, CA (US)

(21) Appl. No.: 15/644,676

(22) Filed: Jul. 7, 2017

(51) Int. Cl. G06Q 30/02; G06N 5/02

(52) U.S. Cl. CPC G06Q 30/0242; G06N 5/022

(57) ABSTRACT

A client relationship management (CRM) application can generate a ranked list of client engagement tools by computing a rank score for available client engagement tools and determining an order among the available client engagement tools based on the rank scores. The CRM application can use one or more trained prediction models and business rules to compute a prediction for success for client engagement tools. For example, the CRM application can use three prediction models, one predicting user selection of a client engagement tool from a list of available client engagement tools; one predicting a user's adopting the recommendation in a client engagement tool; and one predicting a client approving a client engagement tool recommendation. The predictions for success can be combined with estimated benefit values for the client engagement tool to compute the client engagement tool rank score.

### BACKGROUND

Client communication can determine whether an enterprise will succeed or fail. Client communication can occur in a variety of forms from an email suggesting adding variety to a campaign, to a phone call to discuss invoice issues, to an in-person client meeting to discuss news and events relevant to the client. While the options for adjusting how to connect with clients are seemingly infinite, a relationship manager's time and opportunities to connect with clients and make suggestions can be severely limited. The relationship manager's ability to identify available opportunities and select which to act on often defines whether the client relationship will yield a benefit.

Many industries rely on client relationship management (CRM) applications to manage client data and help identify potential client engagement tools. For example, CRM applications can compile information on clients across channels such as a company's website, telephone, chat interfaces, email, direct mail, calendar events, marketing materials, and other social media. CRM applications can also gather client characteristics such as personal information, purchase history, buying preferences, and concerns. Using this data, CRM applications can suggest client engagement tools and give relationship managers the ability to track performance and productivity.

However, due to the ever increasing amount of information available and improvements in the ability of computing systems to automatically transform this data into client engagement tool suggestions, the amount of available client engagement tools at any given time can be overwhelming to relationship managers. This volume can make it difficult for relationship managers to gauge the value of client engagement tools and select which client engagement tools to act upon.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for generating a ranked list of client engagement tools.

FIGS. 5A-C are a flow diagrams illustrating processes used in some implementations for training prediction models to predict success in a stage of client engagement.

FIG. 6 is an example illustrating generating a ranked list of client engagement tools.

FIG. 7 is an example illustrating a user interface that includes a ranked list of client engagement tools.

The techniques introduced here may be better understood by referring to the following Detailed Description in conjunction with the accompanying drawings, in which like reference numerals indicate identical or functionally similar elements.

### DETAILED DESCRIPTION

A client relationship management (CRM) application is described for embodiments of generating a ranked list of client engagement tools. Client engagement tools can come in a variety of forms such as identifying issues with a client's current situation, recommendations for adding a product or adjusting spend, or news or events that may affect a client. The CRM application can generate a ranked list of client engagement tools by computing a rank score for available client engagement tools and determining an order among the available client engagement tools based on the rank scores. A user interface can incorporate a ranked list of client engagement tools in a newsfeed-like interface. Relationship managers (i.e. users) can then view client engagement tools in order of importance and take suggested actions, such as sending an email to the client, schedule a meeting, etc.

In some implementations, client engagement tools can identify an issue with a client account, make product recommendations, or can include news related to a client. Examples of identifying an issue with a client account include under-delivering marketing materials or campaigns, marketing materials that were disapproved, credit or invoice issues, client suspensions, and anomalies in client metrics. Examples of making product recommendations include suggesting new products, advising on audience targeting, guidance on bidding, suggesting creative images, identifying possible campaign objectives, suggesting marketing content, and providing creative insights. Examples of news include latest news items (e.g. that mention the client, are in the client's market, or are otherwise related to a characteristic of the client), events related to the client, analyst commentary, and social media updates (e.g. on Facebook® or Twitter®).

In various implementations, the CRM application can use one or more prediction models and business rules to compute a prediction for success for client engagement tools. A prediction model can be a trained model that generates a prediction for a particular input client engagement tool. The prediction can be for whether a user or client will act on the client engagement tool or can be for an expected importance of a client engagement tool. In some implementations, the CRM application can employ multiple prediction models corresponding to various stages of client engagement. For example, the CRM application can use three prediction models, one predicting user selection of a client engagement tool from a list of available client engagement tools; one predicting a user's adopting the recommendation in a client engagement tool, given that it was selected from the list; and one predicting a client approving a client engagement tool recommendation, given that it the client engagement tool recommendation was adopted by the user. Prediction models can be trained based on a log of user and client actions. The log can include positive items that indicate a client engagement tool was selected, adopted, or acted upon and negative items that indicate the client engagement tool was not selected, adopted, or acted upon. When training, a representation of a client engagement tool can be provided to a model and, if the client engagement tool is part of a positive training item, model parameters can be adjusted to reinforce model output that provides a high prediction for success. Alternatively, if the client engagement tool is part of a negative training item, model parameters can be adjusted to reinforce model output that provides a low prediction for success.

In some implementations, the CRM application can apply business rules when computing a prediction for success score for a client engagement tool. In some implementations, a business rule can be a weight or adjustment that is applied to prediction model output for particular client engagement tools, for client engagement tool categories, or for client engagement tools for particular clients or client types. In some implementations, a business rule can be a “controlling business rule” that is an alternative to using prediction models to compute rank scores.

In various implementations, the prediction models or business rules can be specified generally for all users, can be tailored for a type of user (e.g., all users responsible for a particular country, region, client type, etc.), or can be tailored for a particular user. Prediction models can be tailored by training them using a log of activities from the same user or type of user that the prediction models will be used to make predictions for. Business rules can be tailored by providing separate business rules for each user or user type.

After computing the predictions for success, a value model of the CRM application can combine the predictions with estimated benefit values for client engagement tools to computed a client engagement tool rank score. For example, a rank score for a client engagement tool can be an expected amount of savings or additional revenue that the client engagement tool is expected to generate. In various implementations, the estimated benefit values for a particular client engagement tool can comprise any of: an estimated benefit of a user selecting the client engagement tool, an estimated benefit of the user adopting the action proposed in the client engagement tool, or an estimated benefit of the client approving of the action proposed in the client engagement tool.

The value model can combine the predictions for success from the prediction models with the estimated benefit values to compute the rank score for the client engagement tool. The value model can compute this as an expected value, e.g. prediction value times benefit value. In some implementations, the value model can combine the predictions into a single overall prediction or can combine the expected benefit values into a single benefit value, e.g. by taking the average. In some implementations, the value model can compute an expected value for each client engagement stage by multiplying a prediction value for that stage by an expected benefit value for that stage. The value model can combine these individual stage expected values into a single rank score for the client engagement tool. In some implementations, the value model can weight any of the prediction values or benefit values, e.g. based on a weight value provided for a corresponding client engagement stage.

The CRM application can use the rank scores computed by the value model or controlling business rules, to determining an order for the available client engagement tools. For example, this order can be an order, from greatest to least, of the expected monetary value of each client engagement tool. The CRM application can then provide a representation of the available client engagement tools that incorporates the determined order, e.g. as an option for ordering the list of client engagement tools.

The disclosed technology for generating a ranked list of client engagement tools improves technologies where users have difficulty identifying client engagement tools that will most likely prove beneficial. Presently, client engagement tool recommendations are typically presented as a long sequence, without significantly useful categorization or ordering. The disclosed technology provides a more useful organization for presenting client engagement tools. This improved logical organization based on both predicted use and expected benefit increases users' ability to retrieve and understand client engagement tools. Furthermore, by providing this improved logical organization, users are more likely to be able to directly navigate to client engagement tools they will use, reducing the processing load that would otherwise be required to generate multiple pages of information as users drill in to potential client engagement tools.

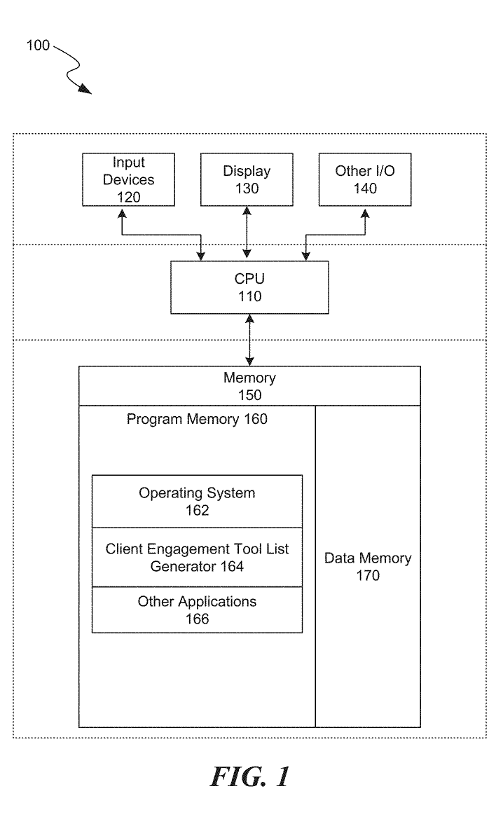

Several implementations are discussed below in more detail in reference to the figures. Turning now to the figures, FIG. 1 is a block diagram illustrating an overview of devices on which some implementations of the disclosed technology can operate. The devices can comprise hardware components of a device 100 that generates a ranked list of client engagement tools. Device 100 can include one or more input devices 120 that provide input to the CPU (processor) 110, notifying it of actions. The actions can be mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other user input devices.

CPU 110 can be a single processing unit or multiple processing units in a device or distributed across multiple devices. CPU 110 can be coupled to other hardware devices, for example, with the use of a bus, such as a PCI bus or SCSI bus. The CPU 110 can communicate with a hardware controller for devices, such as for a display 130. Display 130 can be used to display text and graphics. In some examples, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 can have access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as an operating system 162, client engagement tool list generator 164, and other application programs 166. Memory 150 can also have data memory 170 that can include log data of user activities in various stages of client engagement with corresponding outcomes, client engagement tools, business rules, client engagement tool estimated benefit values, configuration data, settings, user options or preferences, etc., which can be provided to the program memory 160 or any element of the device 100.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

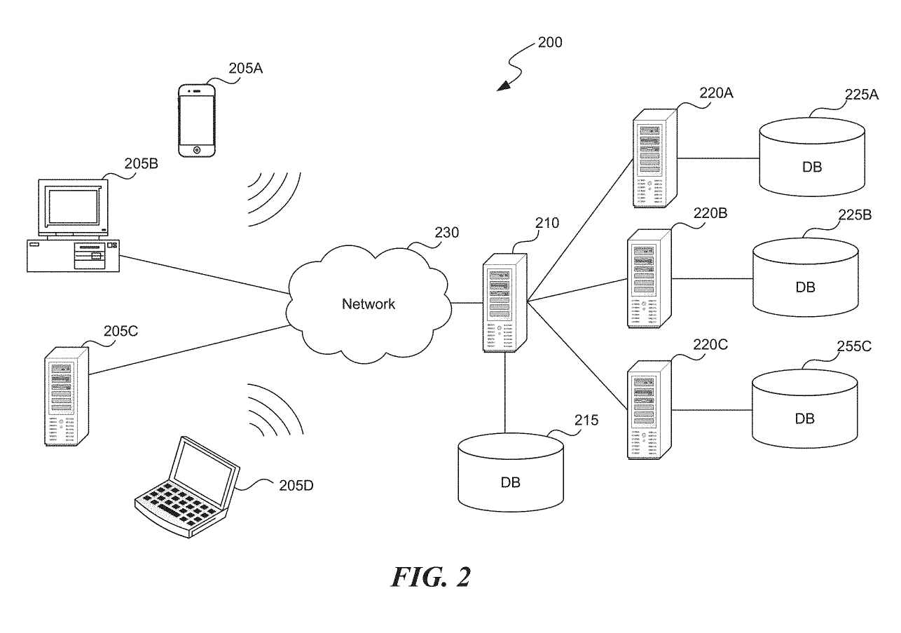

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections 210 through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

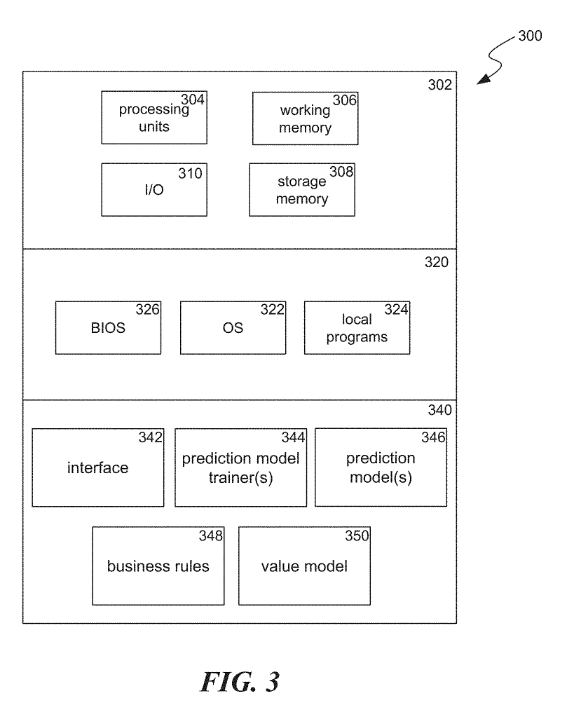

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308, and input and output devices 310. Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include prediction model trainer(s) 344, prediction models 346, business rules 348, value model 350, and components which can be used for transferring data and controlling the specialized components, such as interface 342. In some implementations, components 300 can be in a computing system that is distributed across multiple computing devices or can be an interface to a server-based application executing one or more of specialized components 340.

Prediction model trainer(s) 344 can receive an activity log of positive and negative items, through interface 342, and use the items to train one or more prediction models. Each item in the received activity log can relate to a client engagement tool. In some implementations, each item in the received activity log can also indicate a corresponding client engagement stage. In some implementations, prediction model trainers 344 can determine a client engagement stage for a log item based on a mapping between activity types and client engagement stages. In some implementations, prediction model trainers 344 can train a different prediction model for each stage of client engagement including: selection stage of client engagement in which a user is to select client engagement tools; an adoption stage of client engagement in which a user is to adopt an action proposed in a selected client engagement tool; and a client approval stage of client engagement in which a client is to respond to an action proposed in an adopted client engagement tool.

A “model,” as used herein, refers to a construct that is trained using training data to make predictions or provide probabilities for new data items, whether or not the new data items were included in the training data. For example, training data can include items with various parameters and an assigned classification. A new data item can have parameters that a model can use to assign a classification to the new data item. Examples of models include: neural networks, support vector machines, decision trees, Parzen windows, Bayes, clustering, reinforcement learning, probability distributions, and others. Models can be configured for various situations, data types, sources, and output formats.

In some implementations, a prediction model can be a neural network with multiple input nodes that receive a representation of a client engagement tool. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value classifying the input that, once the model is trained, can be used as a prediction for success of the client engagement tool in client engagement or in a corresponding stage of client engagement.

A neural network can be trained with supervised learning, where the training data includes the log of activities as input and a desired output, such as indicating the corresponding client engagement tool was selected, adopted, or approved by a client. Output from the model can be compared to the desired output for that client engagement tool and, based on the comparison, the neural network can be modified, such as by changing weights between nodes of the neural network or parameters of the functions used at each node in the neural network so the model of output more closely matches the desired output. After applying each of the items in the training data and modifying the neural network in this manner, the neural network model is trained to generate prediction for success of new client engagement tools.

In some implementations, one of the prediction models 346 can be a selection prediction model corresponding to a selection stage of client engagement in which a user is to select a client engagement tool. A selection prediction model can predict success as a likelihood that the user will select a given client engagement tool. A selection prediction model trainer of the prediction model trainers 344 can train the selection prediction model, using, as positive training items, indications from the log that an identified client engagement tool was selected or that a user explicitly approved of the identified client engagement tool. The selection prediction model trainer can further train the selection prediction model using, as negative training items, indications from the log that an identified client engagement tool was presented but was not selected or that a user explicitly disapproved of the identified client engagement tool.

In some implementations, one of the prediction models 346 can be an adoption prediction model corresponding to an adoption stage of client engagement in which a user is to adopt a recommendation made in a client engagement tool. An adoption prediction model can predict success as a likelihood that a user adopts the action proposed in a client engagement tool, given that the user selected the client engagement tool in a previous selection stage of client engagement. An adoption prediction model trainer of the prediction model trainers 344 can train the adoption prediction model, using, as positive training items, indications that an action proposed in an identified client engagement tool was taken. The adoption prediction model trainer can further train the adoption prediction model using, as negative training items, indications that an identified client engagement tool was selected in a previous selection stage of client engagement but that the action proposed in the identified client engagement tool was not taken.

In some implementations, one of the prediction models 346 can be a client approval prediction model corresponding to a client approval stage of client engagement in which a client is to respond to an action proposed in an adopted client engagement tool. A client approval prediction model can predict success as a likelihood that the client approves the action proposed in the adopted client engagement tool, given that a user took the action proposed in an adopted client engagement tool in a previous adoption stage of client engagement. A client approval prediction model trainer of the prediction model trainers 344 can train the client approval prediction model, using, as positive training items, indications that an action proposed in an identified client engagement tool was approved by the client. The client approval prediction model trainer can further train the client approval prediction model using, as negative training items, indications that the action proposed in an identified client engagement tool was taken but that the action proposed in the identified client engagement tool was not approved by the client.

In various implementations, business rules 348 can specify modifications to the predictions for success generated by predictions models 346, can specify modifications to estimated benefit values used by value model 350 to compute rank scores, can cause some client engagement tools to be assigned a rank score using a metric other than combining predictions for success with estimated benefit values, or can modify an order of client engagement tools to satisfy other requirements. Modifications to the predictions for success or estimated benefit values can be weighting factors that apply for particular client engagement tools specified in the business rule, for client engagement tools for particular clients specified in the business rule, for particular stages of client engagement specified in the business rule, or any combination thereof. Business rules, referred to herein as “controlling business rules,” can assign a rank score or determine a place in an order using a metric other than combining predictions for success with estimated benefit values and can specify an alternate algorithm to use. Controlling business rules can be specified for particular client engagement tools specified in the business rule, for client engagement tools for particular clients specified in the business rule, for particular stages of client engagement specified in the business rule, or any combination thereof. For example, client engagement tools of a news or event type may not be as amenable to determining an estimated benefit value, and thus a business rule may specify that client engagement tools of this type should receive a rank score based on an assessment of relevance between the new item or event and a given client. Business rules can also modify an order of client engagement tools by specifying that a certain order must obtain, such as a specified amount of a top threshold of client engagement tools in the order must be of a given type. For example, a business rule may specify that news type client engagement tools must make up at least 5 of the top 20 client engagement tools.

Value model 350 can receive one or more of available client engagement tools, can receive business rules 348, can receive predictions of success from prediction models 346, can receive estimated benefit values through interface 342, and can use these to compute a rank score for the available client engagement tools. Value model 350 can also use the computed rank scores to determine a client engagement tool order for use in a ranked list of client engagement tools. For some client engagement tools for which a controlling business rule doesn't apply, a rank score can be computed by multiplying one or more prediction of success values by a corresponding estimated benefit value.

In some implementations, computing this rank value can include multiplying a prediction of success value for each particular client engagement stage by a corresponding estimated benefit value for that client engagement tool for that particular stage, and summing the results. For example, a client engagement tool can have predictions for success as follows: selection stage: 0.2; adoption stage: 0.15; client approval stage: 0.33; and can have estimated benefit values as follows: selection stage: $68; adoption stage: $214; client approval stage: $509. Thus, the rank score for this client engagement tool can be computed as: 0.2*$68+0.15*$214+0.33*$509=$213.67. In some implementations, a client engagement tool can have an overall estimated benefit value, and the estimated benefit value for each client engagement stage can be computed by taking a percentage of the overall estimated benefit value allocated for that stage. In some implementations, this process for computing a rank score can be modified by weighting each client engagement stage. The previous example where such weighting is used, where example weights are: selection stage: 0.5; adoption stage: 1; and client approval stage: 2, the rank score for this client engagement tool can be computed as: 0.2*$68*0.5+0.15*$214*1+0.33*$509*2=$374.84. In the above example, if the overall estimated benefit is $791 and the stage allocations are assigned as: 0.1 for the selection stage, 0.3 for the adoption stage, and 0.6 for the client approval stage, the rank score for this client engagement tool can be computed as: 0.2*$791*0.1+0.15*$791*0.3+0.33*$791*0.6=$208.03.

In some implementations, computing the rank score can comprise one step of combining the prediction of success values for each particular client engagement stage e.g. by averaging, and another step of multiplying the combined prediction of success value by an overall estimated benefit value for the client engagement tool. For example, a client engagement tool can have predictions for success as follows: selection stage: 0.2; adoption stage: 0.15; client approval stage: 0.33; and can have an estimated benefit value of $791. Thus, the rank score for this client engagement tool can be computed as: ((0.2+0.15+0.33)/3)*$791=$179.29. In these examples, the estimated benefit values are in amounts of currency so the resulting rank score is also represents an amount of currency, however other metrics can be used such as time commitment or level of engagement required.

Once a rank score has been assigned to each client engagement tool, the value model can determine an order for the client engagement tools based on the rank scores. In some implementations, the order can be from highest rank to lowest rank. In some implementations, the order can be modified by other business rules, such as a business rule that specifies a maximum amount of any given type of client engagement tool that can be in a top threshold amount of the order. The order for the client engagement tools can be used in a user interface, such as by providing a “sort by importance” option that, when selected, displays available client engagement tools in the determined order.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

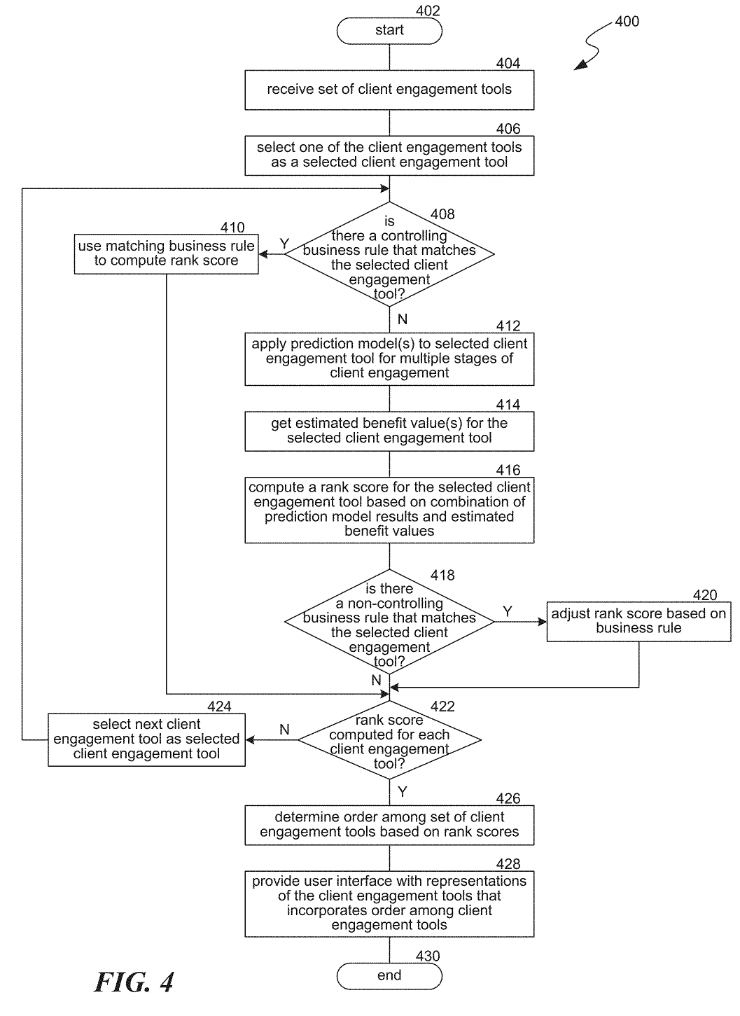

FIG. 4 is a flow diagram illustrating a process 400 used in some implementations for generating a ranked list of client engagement tools. Process 400 begins at block 402 and continues to block 404. In some implementations, process 400 can be performed “just in time,” e.g. as a response to a user request for a list of client engagement tools. In some implementations, process 400 can be performed ahead of time e.g. on a schedule, when servers are determined to have available processing capacity, or upon completion of prediction model training.

At block 404, process 400 can receive a set of client engagement tools. This set of client engagement tools can be the client engagement tools available to a current user. In some implementations, the received set of client engagement tools can be filtered, e.g. by user search or filter terms, such as for a particular client, client type, or client characteristics, for a particular timeframe, for a particular method of client communication, for a type of client engagement tool, for whether the client engagement tools have previously been seen by the current user, or etc.

At block 406, process 400 can select, as a selected client engagement tool, one of the client engagement tools from the set received at block 404. The selected client engagement tool will be operated on by the loop between blocks 408-424 to assign a rank score to the client engagement tool.

At block 408, process 400 can determine whether there is a controlling business rule that matches the selected client engagement tool. In some implementations, a business rule can match a client engagement tool based on one or more of: a match between a client or client type specified in the business rule and a client specified in the selected client engagement tool, a match between a timeframe matching a current time, a match between a client engagement tool type specified in the business rule and a type of the selected client engagement tool, an indicator of whether the client engagement tool is unseen by a current user, a previously computed value for the client engagement tool, or any combination thereof.

If there is a matching business rule, this means that a process, specified by the business rule, other than blocks 412-420 will be used to compute the rank score for the selected business rule. At block 410, process 400 can apply, to the selected client engagement tool, the process specified by the controlling business rule matched to the client engagement tool at block 408 to compute a rank score or scoring parameter for the selected client engagement tool. For example, the process specified by the controlling business rule can indicate that, for a client specified in the client engagement tool, news items should have a ranking based on a computed level of correspondence between the news item and the client. As another example, the process specified by the controlling business rule can specify that client engagement tools with a particular recommendation type should make up the first three client engagement tools in a resulting ranked list of client engagement tools, thus, instead of computing a rank score, the selected client engagement tool should be flagged to satisfy this condition.

At block 412, since no controlling business rule was matched to the selected client engagement tool at block 408, process 400 can apply one or more prediction models to the selected client engagement tool. In some implementations, this can include applying multiple prediction models to the selected client engagement tool, one corresponding to each of several stages of client engagement. For example, at block 412, process 400 can apply: a selection prediction model to compute a value that predicts a likelihood that the user will select the selected client engagement tool; an adoption prediction model to compute a value that predicts a likelihood that the user will adopt the recommendation made in the selected client engagement tool; and a client approval prediction model to compute a value that predicts a likelihood that the client identified in the selected client engagement tool will approve of the recommendation made in the selected client engagement tool.

At block 414, process 400 can obtain one or more estimated benefit values for the selected client engagement tool. In some implementations, the estimated benefit values can be based on data acquired for the selected client engagement tool or for a similar client engagement tool. For example, the estimated benefit value can be an amount of increased revenue observed when another client implemented a recommendation from similar client engagement tool. In some implementations, the estimated benefit value can be computed by a prediction model trained to compute an estimated benefit value. In some implementations, this prediction model can be trained by taking, as input, client engagement tools whose recommendation has been implemented, and adjusting the prediction model parameters so that the output more closely matches an amount of revenue change observed from implementing the recommendation. In some implementations, the estimated benefit value can be manually determined by a system administrator.

In some implementations, the estimated benefit values can be one value for the client engagement tool in each stage of client engagement. In some implementations, the estimated benefit values can be a single benefit value for the client engagement tool. In some implementations, the estimated benefit values can be one value for the client engagement tool in each stage of client engagement, computed by taking a given percentage of a single benefit value for the client engagement tool for each client engagement stage.

At block 416, process 400 can compute a rank score for the selected client engagement tool. This rank score can be computed based on a combination of the prediction value(s) computed at block 412 with the estimated benefit values computed at block 414. As discussed above in relation to value model 350, process 400 can compute the rank score as expected values, multiplying the prediction value(s) by the estimated benefit value(s). Further, in various implementations, the rank score can be computed as a combination of rank scores for each client engagement stage, can be computed using a percentage or part of an overall estimated benefit for each client engagement stage, can combine the prediction values into a single prediction value to combine with an overall estimated benefit, or etc.

At block 418, process 400 can determine whether there is a non-controlling business rule that matches the selected client engagement tool. A match between a business rule and the selected client engagement tool can be determined in a manner similar to the process in block 408. Furthermore, for non-controlling business rules, a match can be found based on a comparison of prediction values from block 412 with prediction values specified in the business rule, a comparison of estimated benefit values from block 414 with estimated benefit values specified in the business rule, or a comparison of a computed rank value from block 416 with a rank value specified in the business rule. For example, a business rule can specify that any client engagement tool with a rank value below $10 should cause the client engagement tool to be excluded from the ranked list of client engagement tools. At block 420, process 400 can use the parameters specified in the business rule determined at block 418 to adjust the computed rank score or otherwise modify the selected client engagement tool, such as by flagging it for a special characteristic when included in a user interface, excluding it from a user interface, providing the selected client engagement tool in an alternate channel, such as through email or a messenger application, or modifying the client engagement tool. For example, a client engagement tool that matches a business rule due to the client engagement tool having a rank value above a threshold can be modified such that, instead of providing the client engagement tool's recommendation through email as the client engagement tool specifies, the client engagement tool's recommendation is suggested to be provided by an in-person meeting. In some implementations, blocks 418 and 420 can be performed prior to block 416 to apply a business rule that adjusts one or more prediction values one or more estimated benefit values prior to computing a rank score.

At block 422, process 400 can determine whether a rank score has been computed for each client engagement tool by the process between blocks 408-424. If not, process 400 continues to block 424 where a next client engagement tool is selected as the current client engagement tool to be operated on by the loop between block 408-422. If so, process 400 continues to block 426.

At block 426, process 400 can determine an order among the set of client engagement tools based on the rank scores. In some implementations, the order can also be determined based on flags or other indicators set by business rules matched at block 408 or 418. In some implementations, the order can be an order of the rank score from highest to lowest. For example, where the rank score indicates an expected amount of currency a client engagement tool is likely to generate, the order can be the client engagement tools ordered from most amount of expected generated currency to least amount of expected generated currency.

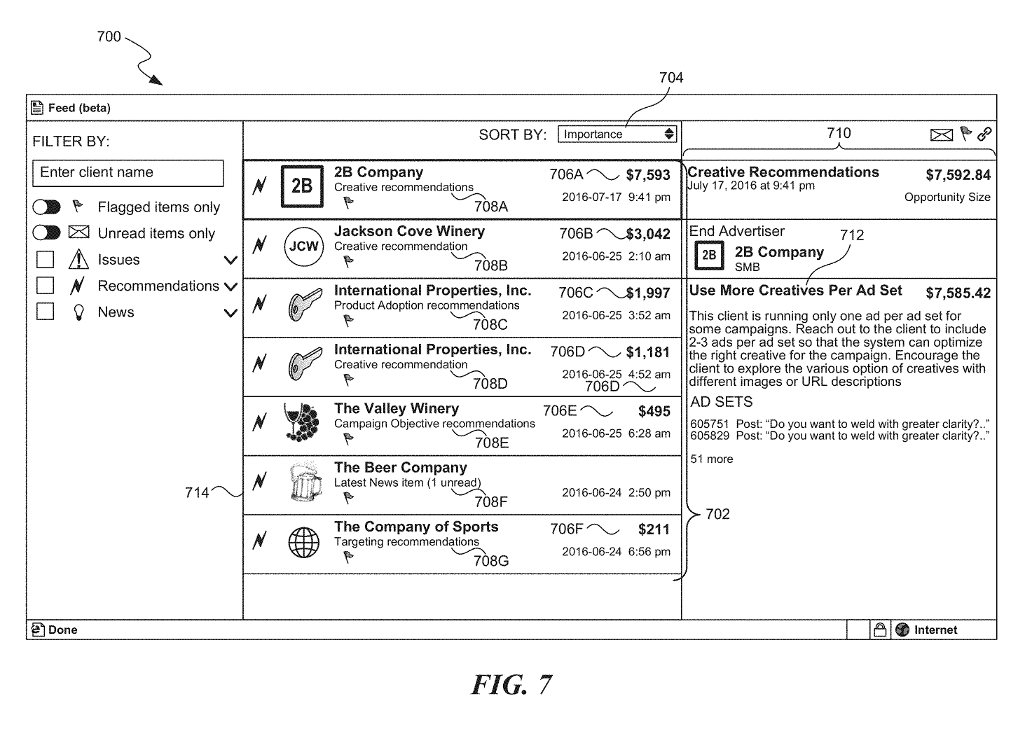

At block 428, process 400 can provide a user interface with representations of the client engagement tools, with a relationship among the client engagement tools that incorporates the order. For example, the user interface can include a listing of client engagement tools in the determined order. As another example, the user interface can include a “sort by” control that will list the client engagement tools in the determined order when the “sort by” control is set to “importance” (see e.g. FIG. 7). In some implementations, process 400 can use the client engagement tool order in a manner other than incorporating it in a user interface, such as providing the ordered client engagement tools to another application for further processing. Process 400 can then proceed to block 430, where it ends.

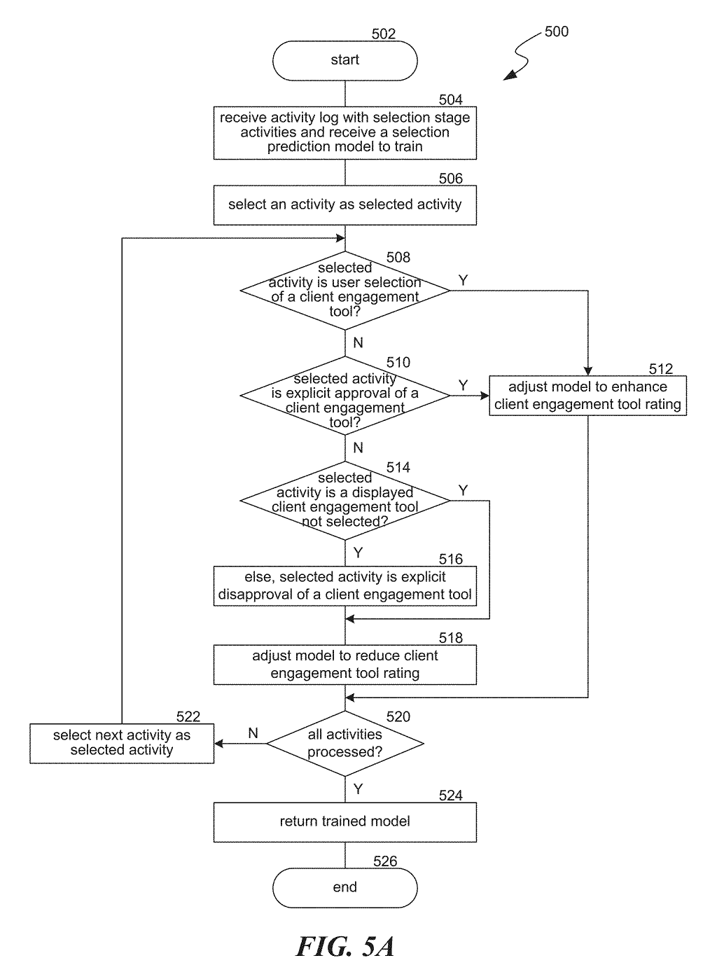

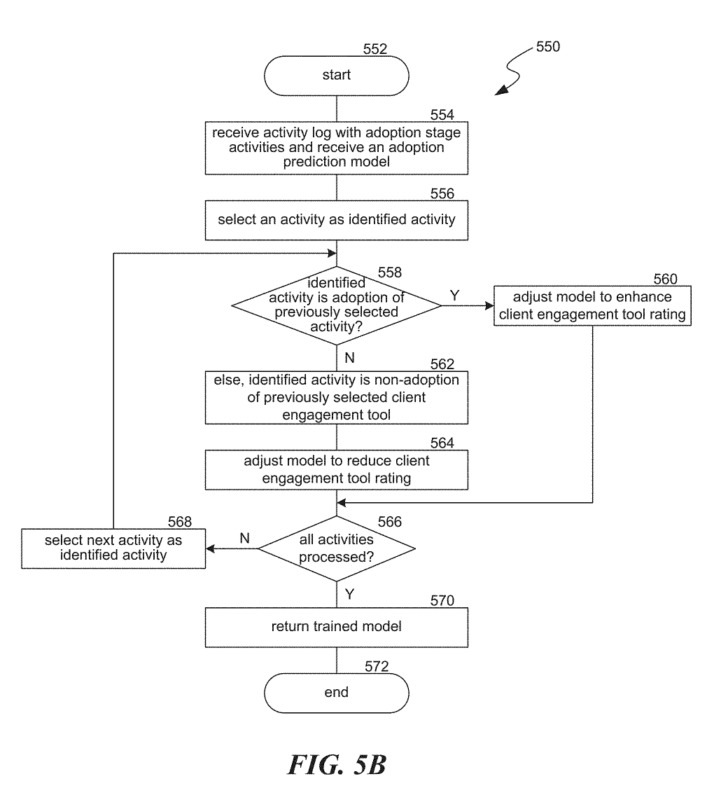

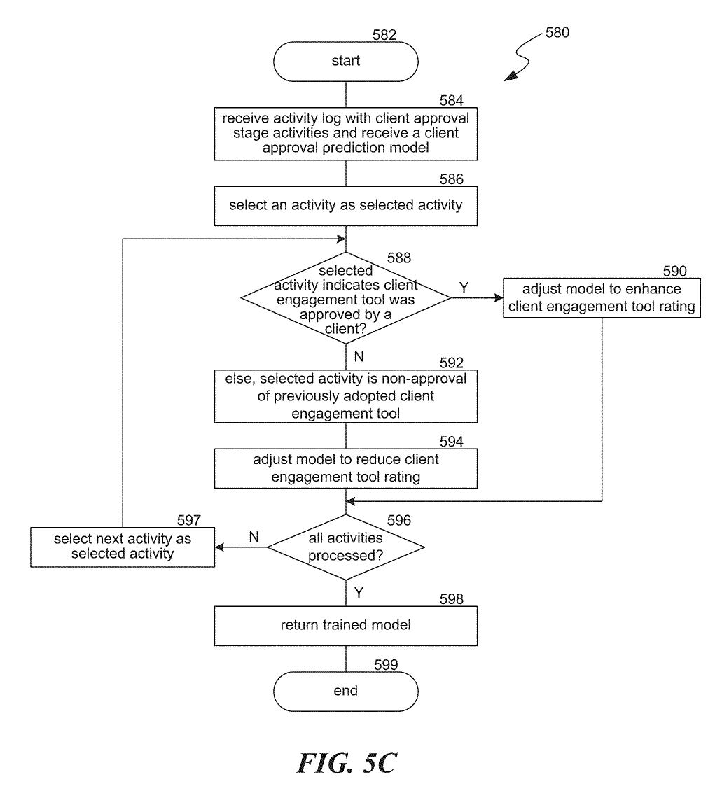

FIG. 5A is a flow diagram illustrating a process 500 used in some implementations for training a selection prediction model to predict success in a selection stage of client engagement. Process 500 begins at block 502 and continues to block 504. At block 504, process 500 can receive an activity log with at least selection stage activities and a selection stage prediction model, such as a neural network, to train. In some implementations, the prediction model is to be trained for a specific user, thus the activity log can include selection stage activities previously performed by that user. In some implementations, the prediction model is to be trained for a specific category of user, thus the activity log can include selection stage activities previously performed by users in that category. In some implementations, the prediction model is to be trained for users generally, thus the activity log can include selection stage activities previously performed by any user.

At block 506, process 500 can select, as a selected activity, a selection stage activity from the activity log. The selected activity can be used by the loop between blocks 508-522 to partially train the selection stage prediction model.

At block 508, process 500 can determine whether the selected activity indicates a user selected a client engagement tool. For example, this can be an indication that when a user was viewing a user interface with a list of client engagement tools, such as user interface 700, the user selected a particular listed client engagement tool. If so process 500 can continue to block 512. If not, process 500 can continue to block 510. At block 510, process 500 can determine whether the selected activity indicates a user explicitly approved of a client engagement tool. For example, a list of client engagement tools or a details page for an individual client engagement tool can include controls, corresponding to the client engagement tools, allowing the user to provide approval (e.g. a “like,” “thumbs up,” or a rating) for the corresponding client engagement tool. If so, process 500 can continue to block 512. If not, process 500 can continue to block 514.

At block 512, process 500 has determined, through block 508 or 510, that the activity is a positive item, indicating that the client engagement tool was selected or approved of. Process 500 can then provide a representation of the client engagement tool to the selection prediction model and get an output. Parameters (e.g. weights of nodes or of edges between nodes) can be adjusted such that the output of the selection model more closely indicates the entered client engagement tool will likely be successful. For example, the model output can be a decimal between 0 and 1, where 0 indicates the client engagement tool won't be successful (not selected) and 1 indicates the client engagement tool will be successful (selected). At block 512, the model parameters can be adjusted such that the model output is closer to 1.

At block 514, process 500 can determine whether the selected activity indicates a client engagement tool was displayed to a user but was not selected. For example, this can be an indication that when a user was viewing a user interface with a list of client engagement tools, such as user interface 700, the client engagement tool was included in the list but was not selected. If so, process 500 can continue to block 518. If not, process 500 can continue to block 516. At block 516, process 500 can determine that the selected activity indicates a user explicitly disapproved of a client engagement tool and proceeds to block 518. For example, a list of client engagement tools or a details page for an individual client engagement tool can include controls, corresponding to the client engagement tools, allowing the user to provide disapproval (e.g. a “dislike,” “thumbs down,” or a rating) for the corresponding client engagement tool. In some implementations, no actual determination is made at block 516 and the remaining default action is to continue to block 518.

At block 518, process 500 has determined, through block 514 or 516, that the activity is a negative item, indicating that the client engagement tool was displayed but was not selected or was disapproved of. Process 500 can then provide a representation of the client engagement tool to the selection prediction model and get an output. Parameters (e.g. weights of nodes or of edges between nodes) can be adjusted such that the output of the selection model more closely indicates the entered client engagement tool will not likely be successful. For example, the model output can be a decimal between 0 and 1, where 0 indicates the client engagement tool won't be successful (not selected) and 1 indicates the client engagement tool will be successful (selected). At block 518, the model parameters can be adjusted such that the model output is closer to 0.

From block 518 or 512, process 500 can continue to block 520. At block 520, process 500 can determine whether all the selection stage activities in the received log have been used in the loop between blocks 508-522 to partially train the selection prediction model. If not, process 500 can continue to block 522 where a next selection stage activity from the log can be set as the selected activity to be operated on by the loop between blocks 508-522. If so, process 500 can continue to block 524 where the trained selection stage prediction model can be returned. Process 500 can then continue to block 526, where it ends.

FIG. 5B is a flow diagram illustrating a process 550 used in some implementations for training an adoption prediction model to predict success in an adoption stage of client engagement. Process 550 begins at block 552 and continues to block 554. At block 554, process 550 can receive an activity log with at least adoption stage activities and an adoption stage prediction model, such as a neural network, to train. In some implementations, the prediction model is to be trained for a specific user, thus the activity log can include adoption stage activities previously performed by that user. In some implementations, the prediction model is to be trained for a specific category of user, thus the activity log can include adoption stage activities previously performed by users in that category. In some implementations, the prediction model is to be trained for users generally, thus the activity log can include adoption stage activities previously performed by any user.

At block 556, process 550 can select, as a selected activity, an adoption stage activity from the activity log. The selected activity can be used by the loop between blocks 558-568 to partially train the adoption stage prediction model.

At block 558, process 550 can determine whether the selected activity indicates a user adopted a previously selected client engagement tool. Adoption of an activity can mean that the user took the client engagement action proposed in the client engagement tool. For example, the client engagement tool can propose that the user email a client about a new product and the client engagement tool is adopted if the user sends this email. The adoption activities in the activity log can be determined by monitoring user communications, calendar events, or through users manually specifying what actions they took. In some implementations, client engagement tools provide the communication tool to complete the client engagement tool's suggestion. For example, the client engagement tool may suggest messaging a client about a new product, can provide a template for the message, and can allow the user to send the message directly from the details page of the client engagement tool. When this message is sent, the action can be logged in the activity log. As another example, the client engagement tool may suggest having a meeting with a client about increasing the client's market campaign. The system can monitor the user's calendar to determine if the meeting with the client was scheduled, and if so, logged in the activity log.

If the client engagement tool's suggestion was adopted, process 550 can continue to block 560. If not, process 550 can continue to block 562. At block 560, process 550 has determined that the activity is a positive item, indicating that the suggestion in the client engagement tool was adopted. Process 550 can then provide a representation of the client engagement tool to the adoption prediction model and get an output. Parameters (e.g. weights of nodes or of edges between nodes) can be adjusted such that the output of the adoption model more closely indicates the entered client engagement tool will likely be successful. For example, the model output can be a decimal between 0 and 1, where 0 indicates the client engagement tool won't be successful (not adopted) and 1 indicates the client engagement tool will be successful (adopted). At block 560 the model parameters can be adjusted such that the model output is closer to 1.

At block 562, process 550 can determine that the selected activity indicates a client engagement tool was selected in a previous selection stage of client engagement, but that the suggestion in the client engagement tool was not adopted. This can occur in a similar manner to determining whether the client engagement tool suggestion was adopted. Process 550 can then continue to block 564. In some implementations, no actual determination is made at block 562 and the remaining default action is to continue to block 564.

At block 564, process 550 has determined that the activity is a negative item, indicating that the client engagement tool was selected in a previous selection stage of client engagement, but that the suggestion in the client engagement tool was not adopted. Process 550 can then provide a representation of the client engagement tool to the adoption prediction model and get an output. Parameters (e.g. weights of nodes or of edges between nodes) can be adjusted such that the output of the adoption model more closely indicates the entered client engagement tool will not likely be successful. For example, the model output can be a decimal between 0 and 1, where 0 indicates the client engagement tool won't be successful (not adopted) and 1 indicates the client engagement tool will be successful (adopted). At block 564 the model parameters can be adjusted such that the model output is closer to 0.

From block 560 or 564, process 550 can continue to block 566. At block 566, process 550 can determine whether all the adoption stage activities in the received log have been used in the loop between blocks 558-568 to partially train the adoption prediction model. If not, process 550 can continue to block 568 where a next adoption stage activity from the log can be set as the selected activity to be operated on by the loop between blocks 558-568. If so, process 550 can continue to block 570 where the trained adoption stage prediction model can be returned. Process 550 can then continue to block 572, where it ends.

FIG. 5C is a flow diagram illustrating a process 580 used in some implementations for training a client approval prediction model to predict success in a client approval stage of client engagement. Process 580 begins at block 582 and continues to block 584. At block 584, process 580 can receive an activity log with at least client approval stage activities and a client approval stage prediction model, such as a neural network, to train. In some implementations, the prediction model is to be trained for a specific user, thus the activity log can include client approval stage activities corresponding to that user. In some implementations, the prediction model is to be trained for a specific category of user, thus the activity log can include client approval stage activities corresponding to users in that category. In some implementations, the prediction model is to be trained for users generally, thus the activity log can include client approval stage activities corresponding to any user.

At block 586, process 580 can select, as a selected activity, a client approval stage activity from the activity log. The selected activity can be used by the loop between blocks 588-597 to partially train the client approval stage prediction model.

At block 588, process 580 can determine whether the selected activity indicates a client approved of a previously adopted client engagement tool. Client approval of an activity can mean that the client took the recommendation provided by a user as recommended in the client engagement tool. For example, the client engagement tool can propose that the user email a client about a new product, which the user does, and the client engagement tool is approved by the client if the client uses the new product. The client approval activities in the activity log can be determined by monitoring client metrics and comparing them to client engagement tools identified as adopted. For example, the client engagement tool may suggest messaging a client about a new product, and allow the user to send the message directly from the details page of the client engagement tool. When this message is sent, the client engagement tool can be identified as adopted. The client engagement tool's recommendation can be identified as approved by the client when the adopted client engagement tool recommendation is implemented (e.g. the client used the new product), which is logged in the activity log.

If the client engagement tool's suggestion was approved by the client, process 580 can continue to block 590. If not, process 580 can continue to block 592. At block 590, process 580 has determined that the activity is a positive item, indicating that the suggestion in the client engagement tool was approved by the client. Process 580 can then provide a representation of the client engagement tool to the client approval prediction model and get an output. Parameters (e.g. weights of nodes or of edges between nodes) can be adjusted such that the output of the client approval model more closely indicates the entered client engagement tool will likely be successful. For example, the model output can be a decimal between 0 and 1, where 0 indicates the client engagement tool won't be successful (not client-approved) and 1 indicates the client engagement tool will be successful (client-approved). At block 590, the model parameters can be adjusted such that the model output is closer to 1.

At block 592, process 580 can determine that the selected activity indicates a client engagement tool was adopted in a previous adoption stage of client engagement, but that the suggestion in the client engagement tool was not approved by a client. This can occur in a similar manner to determining whether the client engagement tool suggestion was approved by a client. Process 580 can then continue to block 594. In some implementations, no actual determination is made at block 592 and the remaining default action is to continue to block 594.

At block 594, process 580 has determined that the activity is a negative item, indicating that the client engagement tool was adopted in a previous adoption stage of client engagement, but that the suggestion in the client engagement tool was not approved by a client. Process 580 can then provide a representation of the client engagement tool to the client approval prediction model and get an output. Parameters (e.g. weights of nodes or of edges between nodes) can be adjusted such that the output of the client approval model more closely indicates the entered client engagement tool will not likely be successful. For example, the model output can be a decimal between 0 and 1, where 0 indicates the client engagement tool won't be successful (not client-approved) and 1 indicates the client engagement tool will be successful (client-approved). At block 594 the model parameters can be adjusted such that the model output is closer to 0.

From block 590 or 594, process 580 can continue to block 596. At block 596, process 580 can determine whether all the client approval stage activities in the received log have been used in the loop between blocks 588-597 to partially train the client approval prediction model. If not, process 580 can continue to block 597 where a next client approval stage activity from the log can be set as the selected activity to be operated on by the loop between blocks 588-597. If so, process 580 can continue to block 598 where the trained client approval stage prediction model can be returned. Process 580 can then continue to block 599, where it ends.

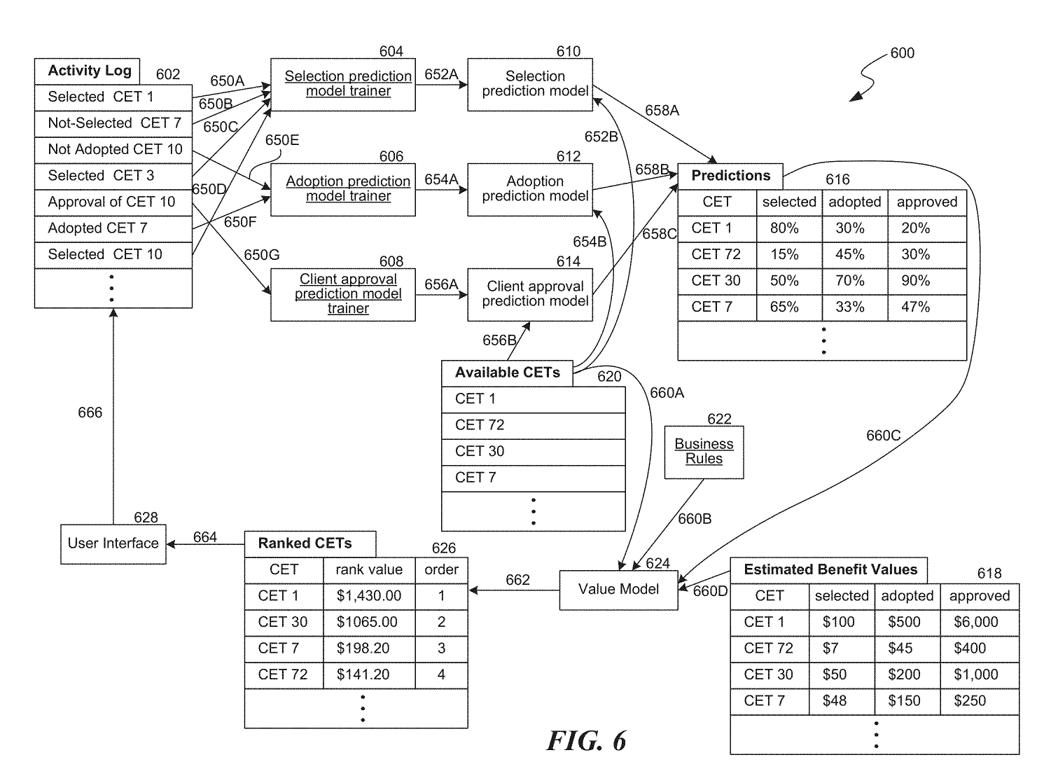

FIG. 6 is an example 600 illustrating generating a ranked list of client engagement tools. Example 600 begins with an activity log 602 including multiple observed activities in various stages of client engagement. At 650, items from the activity log are provided to corresponding prediction model trainers. More specifically, at 650A-D, the items corresponding to the selection stage of client engagement are provided to selection prediction model trainer 604; at 650E-F, the items corresponding to the adoption stage of client engagement are provided to adoption prediction model trainer 606; and at 650G, the item corresponding to the client approval stage of client engagement is provided to client approval prediction model trainer 608. Other items, not shown, from the activity log 602 can be provided to the corresponding prediction model trainer. Each of selection prediction model trainer 604, adoption prediction model trainer 606, and client approval prediction model trainer 608 can use the received items to train a prediction model for that stage of client engagement.

At 652A, selection prediction model trainer 604 can produce selection prediction model 610. At 652B, selection prediction model 610 can receive a set of available client engagement tools. Example 600 can apply selection prediction model 610 to each of the available client engagement tools to generate, at 658A, the “selected” column of Predictions 616. At 654A, adoption prediction model trainer 606 can produce adoption prediction model 612. At 654B, adoption prediction model 612 can receive the set of available client engagement tools. Example 600 can apply adoption prediction model 612 to each of the available client engagement tools to generate, at 658B, the “adopted” column of Predictions 616. At 656A, client approval prediction model trainer 608 can produce client approval prediction model 614. At 656B, client approval prediction model 614 can receive the set of available client engagement tools. Example 600 can apply client approval prediction model 614 to each of the available client engagement tools to generate, at 658C, the “approved” column of Predictions 616.

At step 660, example 600 can provide, to Value Model 624, various data needed to compute client engagement tool rank scores. More specifically, at 660A example 600 provides the available client engagement tools 620; at 660B, example 600 provides any business rules that might match the available client engagement tools (for clarity, controlling business rules are not included in example 600); at 660C, example 600 provides the Predictions 616 computed by prediction models 610-614; and at 660D, example 600 provides Estimated Benefit Values 618. In example 600, Estimated Benefit Values 618 are divided such that each client engagement tool has a value for each stage of client engagement.

Value Model 624, at step 662, produces Ranked client engagement tools 626. In example 600, Value Model 624 computes the rank score for each client engagement tool by multiplying the prediction for that client engagement tool for each client engagement stage by the estimated benefit value for that client engagement tool for the corresponding client engagement stage, and summing the result. For example, the rank score for client engagement tool1 is computed as 0.8*$100+0.3*$500+0.2*$6000=$1430. Further, in example 600, no Business Rules 622 applied to modify the rank scores of any client engagement tool.

At step 664, example 600 can incorporate the Ranked Client Engagement Tools 626 into User Interface 628. The resulting user interface can be similar to example user interface 700. User interface 628 can be provided to a client device, and user and client activities relating to the client engagement tools can be logged. At step 666, the logged activities can be provided to augment or replace Activity Log 602, which can be used to retrain or update the training of the Prediction Models 610-614.

FIG. 7 is an example 700 illustrating a user interface that includes a ranked list of client engagement tools. Example user interface 700 includes a list 702 of client engagement tools (CETs). Example user interface 700 includes a dropdown 704 allowing the user to sort the CETs on various metrics, one of which is “Importance.” Importance here refers to an amount 706A-F that is expected to be gained through the CET. The importance values 706A-F are also the rank scores computed for each CET. While CET 714 doesn't have a rank score, a business rule specified that at least one of the top 7 CETs should be a news item. Thus CET 714 was included in list 702. Each CET has a type 708A-G. Selecting one of the CETs can display a corresponding details page 710 for the selected CET. The details page can include various information for the CET, such as a recommended action 712.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for generating a ranked list of client engagement tools, the method comprising:
receiving indications of multiple client engagement tools;
for each particular client engagement tool of the multiple client engagement tools:
applying multiple prediction models to the particular client engagement tool, wherein each prediction model provides a prediction for success in a corresponding stage of client engagement;
obtaining one or more estimated benefit values for the particular client engagement tool;
computing a rank score for the particular client engagement tool based on a combination of the predictions for success and the estimated benefit values for the particular client engagement tool;
determining an order, for the multiple client engagement tools, based on the rank score for each of the particular client engagement tools; and
providing a representation of the multiple client engagement tools that incorporates the order for the multiple client engagement tools.

2. The method of claim 1,
wherein the multiple prediction models include a selection prediction model corresponding to a selection stage of client engagement in which a user is to select client engagement tools; and
wherein the selection prediction model predicts success as a likelihood that the user will select a given client engagement tool.

3. The method of claim 2,
wherein the selection prediction model was trained based on a log of activities taken in the selection stage of client engagement; and
wherein the log of activities comprises one or more of:
indications that an identified client engagement tool was selected, wherein the indications that an identified client engagement tool was selected were used in the training of the selection prediction model to indicate a correct prediction;
indications that the identified client engagement tool was presented but was not selected, wherein the indications that an identified client engagement tool was presented but was not selected were used in the training of the selection prediction model to indicate an incorrect prediction;
indications that a user explicitly approved of the identified client engagement tool, wherein the indications that a user explicitly approved of the identified client engagement tool were used in the training of the selection prediction model to indicate a correct prediction;
indications that the user explicitly disapproved of the identified client engagement tool, wherein the indications that the user explicitly disapproved of the identified client engagement tool were used in the training of the selection prediction model to indicate an incorrect prediction; or
any combination thereof.

4. The method of claim 1,
wherein the multiple prediction models include an adoption prediction model corresponding to an adoption stage of client engagement in which a user is to adopt an action proposed in a selected client engagement tool; and
wherein the adoption prediction model predicts success as a likelihood that the user adopts the action proposed in the selected client engagement tool, given that the user selected the selected client engagement tool in a previous selection stage of client engagement.

5. The method of claim 4,
wherein the adoption prediction model was trained based on a log of activities taken in the adoption stage of client engagement; and
wherein the log of activities comprises one or more of:
positive indications that an action proposed in an identified client engagement tool was taken, wherein the positive indications were used in the training of the adoption prediction model to indicate a correct prediction;
negative indications that the identified client engagement tool was selected in the previous selection stage of client engagement but that the action proposed in the identified client engagement tool was not taken, wherein the negative indications were used in the training of the adoption prediction model to indicate an incorrect prediction; or
any combination thereof.

6. The method of claim 1,
wherein the multiple prediction models include a client approval prediction model corresponding to a client approval stage of client engagement in which a client is to respond to an action proposed in an adopted client engagement tool; and
wherein the client approval prediction model predicts success as a likelihood that the client approves the action proposed in the adopted client engagement tool, given that a user took the action proposed in an adopted client engagement tool in a previous adoption stage of client engagement.

7. The method of claim 6,
wherein the client approval prediction model was trained based on a log of activities taken in the client approval stage of client engagement; and
wherein the log of activities comprises one or more of:
positive indications that an action proposed in an identified client engagement tool was approved by the client, wherein the positive indications were used in the training of the client approval prediction model to indicate a correct prediction;
negative indications that the action proposed in the identified client engagement tool was taken but that the action proposed in the identified client engagement tool was not approved by the client, wherein the negative indications were used in the training of the adoption prediction model to indicate an incorrect prediction; or
any combination thereof.

8. The method of claim 1, wherein at least one model, of the multiple prediction models, was trained based on a log of activities specific to an individual user.

9. The method of claim 1, wherein at least one model, of the multiple prediction models, was trained based on a log of activities specific to an identified type or category of user.

10. The method of claim 1,
wherein the multiple prediction models include:
a selection prediction model corresponding to a selection stage of client engagement in which a user is to select a selected client engagement tool,
an adoption prediction model corresponding to an adoption stage of client engagement in which a user is to adopt an action proposed in the selected client engagement tool, and
a client approval prediction model corresponding to a client approval stage of client engagement in which a client is to respond to the action proposed in the selected client engagement tool; and
wherein the one or more estimated benefit values for the particular client engagement tool comprise:
a selection value for an estimated benefit of the user selecting the selected client engagement tool,
an adoption value for an estimated benefit of the user adopting the action proposed in the selected client engagement tool, and
a client approval value for an estimated benefit of the client approving of the action proposed in the selected client engagement tool.

11. The method of claim 1, further comprising:
combining the predictions for success in the corresponding stages of client engagement into a single success prediction for the particular client engagement tool;
wherein computing the rank score for the particular client engagement tool comprises multiplying the single success prediction by at least one of the one of more estimated benefit values for the particular client engagement tool.

12. The method of claim 1,
wherein the one or more estimated benefit values comprise multiple estimated benefit values with at least one estimated benefit value corresponding to each of the predictions for success; and
wherein each selected benefit value, of the multiple estimated benefit values, is computed by taking a corresponding percentage of an overall benefit value for the particular client engagement tool, wherein each corresponding percentage is provided for the particular client engagement tool, for the stage of client engagement corresponding to the prediction models that produced the prediction for success that corresponds to the selected benefit value.

13. The method of claim 1 further comprising using one or more business rules to adjust one or more of: the predictions for success, the estimated benefit values for the particular client engagement tool, the rank score, the determined order, or any combination thereof.

14. The method of claim 1 further comprising:
receiving one or more additional client engagement tools;
determining that the one or more additional client engagement tools corresponds to a controlling business rule; and
generating a ranking score for the one or more additional client engagement tools based on the controlling business rule without using any of the prediction models of the multiple prediction models.

15. A computer-readable storage medium storing instructions that, when executed by a computing system, cause the computing system to perform operations for generating a ranked list of client engagement tools, the operations comprising:
receiving indications of multiple client engagement tools;
for each particular client engagement tool of the multiple client engagement tools:
applying one or more prediction models to the particular client engagement tool, wherein the one or more prediction models provide a prediction for success in stages of client engagement;
obtaining one or more estimated benefit values for the particular client engagement tool;
computing a rank score for the particular client engagement tool based on a combination of the prediction for success and the one or more estimated benefit values for the particular client engagement tool;
determining an order, for the multiple client engagement tools, based on the rank score for each of the particular client engagement tools; and
generating a user interface that includes representations of the multiple client engagement tools in the order for the multiple client engagement tools.

16. The computer readable medium of claim 15, wherein at least one model, of the one or more prediction models, was trained based on a log of activities specific to an individual user.

17. The computer readable medium of claim 15, wherein at least one model, of the one or more prediction models, was trained based on a log of activities specific to an identified type or category of user.

18. A system for generating a ranked list of client engagement tools, the system comprising:
one or more processors;
a memory;
an interface configured to receive indications of multiple client engagement tools, wherein each of the multiple client engagement tools is associated with one or more estimated benefit values;
one or more prediction models configured to, for each particular client engagement tool of the multiple client engagement tools, be applied to the particular client engagement tool, wherein the one or more prediction models provide a prediction for success in stages of client engagement; and
a value model configured to:
compute a rank score for each of the particular client engagement tool based on a combination of the prediction for success and one or more estimated benefit values associated with the particular client engagement tool; and
determine an order, for the multiple client engagement tools, based on the rank score for each of the particular client engagement tools;
wherein the interface is further configured to provide, to a client device, a user interface that includes representations of the multiple client engagement tools using the order for the multiple client engagement tools.

19. The system of claim 18,
wherein the one or more prediction models include:
a selection prediction model corresponding to a selection stage of client engagement in which a user is to select a selected client engagement tool,
an adoption prediction model corresponding to an adoption stage of client engagement in which a user is to adopt an action proposed in the selected client engagement tool, and
a client approval prediction model corresponding to a client approval stage of client engagement in which a client is to respond to the action proposed in the selected client engagement tool; and
wherein the one or more estimated benefit values for the particular client engagement tool comprise:
a selection value for an estimated benefit of the user selecting the selected client engagement tool,
an adoption value for an estimated benefit of the user adopting the action proposed in the selected client engagement tool, and
a client approval value for an estimated benefit of the client approving of the action proposed in the selected client engagement tool.

20. The system of claim 18 further comprising using one or more business rules to adjust one or more of: one of the predictions for success, one of the estimated benefit values, one of the rank scores, the determined order, or any combination thereof.
